(19) United States
(12) Patent Application Publication
(10) Pub. No.: US 2016/0125083 A1
(43) Pub. Date: May 5, 2016

(54) INFORMATION SENSORS FOR SENSING WEB DYNAMICS

(71) Applicants: Zhicheng DOU, Shanghai (CN); Ji-Rong WEN, Shanghai (CN); MICROSOFT TECHNOLOGY LICENSING, LLC, Redmond, WA (US)

(72) Inventors: Zhicheng Dou, Beijing (CN); Ji-Rong Wen, Beijing (CN)

(21) Appl. No.: 14/896,339

(22) PCT Filed: Jun. 7, 2013
(86) PCT No.: PCT/CN2013/076908

§ 371 Date: Dec. 4, 2015

(51) Int. Cl. G06F 17/30

(52) U.S. Cl. CPC G06F 17/30864

(57) ABSTRACT

Disclosed herein are techniques and systems for building “information sensors,” which are programmable “focused crawlers” that periodically discover, extract, analyze and aggregate structured information around a topic from the Web. A platform for building an information sensor allows a user to specify one or more data elements within a data source that the user desires to monitor, and an update frequency at which the data elements are to be extracted. Code may be generated based on the user specifications for creation and submission of the information sensor for storage in a database with metadata containing the code and update frequency. Once created, information sensors are scanned to check if running conditions are met, and if met, they may be executed by retrieving the metadata using a sensor identifier (ID). The code is executed to locate a data source, and periodically extract specified data elements therefrom to output structured time-series data.

### BACKGROUND

With the rapid growth of the World Wide Web (“the Web”), there are associated challenges in making sense of the data thereon. Specifically, data on the Web has properties described by the “Five Vs” of big data: large Volume (amount of data), high Velocity (speed of data in and out), high Variety (range of data types and sources), high Variability (extent to which data points differ from each other), and unknown Veracity (accuracy). For example, around the time of the 2012 U.S. presidential election, there were millions (i.e., large Volume) of webpages about the topic “who will win in the 2012 U.S. presidential election.” Many of them were changing very frequently (i.e., high Velocity), were from different data sources and in different formats (i.e., high Variety), and were highly “noisy.” In other words, users of the Web are often faced with “information overload” where they are forced to browse a large number of webpages, analyze and summarize the information contained therein, and repeat these actions periodically as new webpages are created and as information on them changes frequently.

In addition to the information overload problem described above, the Web lacks an explicit model for the temporal dimension of data, or how the data changes with time. That is, most websites are capable of providing current and static information to users, such as a current price of a product. However, a user's information needs pertaining to the dynamics of such information over time are not satisfied by such websites.

### SUMMARY

The Web is dynamic, and the information on the Web is changing with time. Described herein are techniques and systems for building virtual Web sensors, referred to herein as “information sensors,” which may be used to detect changes in Web data over time. An information sensor is a programmable “focused crawler” that periodically discovers, extracts, analyzes and aggregates structured information around a topic from the Web. Like a physical sensor that measures a physical quantity in the real (physical) world, an information sensor may be applied to the virtual world (i.e., the Web) to measure data and detect any changes in the data over time. Also described herein are techniques and systems for implementing information sensors to sense the dynamics of the Web.

In some embodiments, a platform for building an information sensor allows a user to specify one or more data elements within a data source that the user desires to monitor using an information sensor, and an update frequency at which the information sensor is to extract the one or more data elements. In some embodiments, code is generated based on the user specifications of the data elements and the update frequency. The information sensor may be submitted by the user for storage in a database along with metadata specifying the code and the update frequency for the information sensor.

In some embodiments, a process for executing an information sensor includes scanning a set of information sensors to check if running conditions are met for any of the information sensors, and if such running conditions are met, retrieving metadata associated with an identifier (ID) of the information sensor. The metadata may include an update frequency and code to periodically extract one or more data elements from a data source. The code may then be executed to locate at least one data source, identify the one or more data elements within the data source, and periodically extract the one or more data elements according to the update frequency. The extracted data elements may be stored as data points. In some embodiments, the extracted data elements are further analyzed and aggregated to obtain information desired by a user. Over time, the information sensor generates a structured time series to model the dynamics of the Web data.

The information sensors described herein may be used in a variety of scenarios, such as by end Web users to track time-sensitive information (e.g., tracking the price of a product), or by enterprises to track and analyze important information related to their business (e.g., tracking sentiment pertaining to a product or service), to name only a couple of scenarios. By utilizing information sensors atop the traditional Web, the Web becomes more meaningful and structured, as well as more usable, especially for temporal information related tasks.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicates similar or identical items.

FIG. 1 illustrates an example architecture for building and implementing information sensors to sense the dynamics of Web data.

FIG. 2 illustrates an example structure of an information sensor.

FIG. 3 is a block diagram illustrating an example implementation of an information sensor service including a sensor worker module with various modules therein for executing an information sensor.

FIG. 4 is a flow diagram of an illustrative process for executing an information sensor to extract structured information from a data source at a predetermined update frequency.

FIG. 5 is a flow diagram of an illustrative process for analyzing data points obtained by an information sensor and carrying out multiple options including determining a threshold crossing within the data, detecting peaks within the data, and/or forecasting future data points based on historical data.

FIG. 6 illustrates an example architecture of an information sensor platform for creation and management of information sensors.

FIG. 7A illustrates an example screen rendering of a user interface (UI) enabling user selection of a data element within a data source for extraction by an information sensor.

FIG. 7B illustrates an example screen rendering of a UI enabling viewing of particular information sensors and associated published data.

FIG. 8 illustrates an example screen rendering of an integrated development environment (IDE) for building information sensors.

FIGS. 9A and 9B illustrate example wizard tools used for specifying configurable properties and constraints of an information sensor and submitting the information sensor for implementation.

FIG. 10 is a block diagram that illustrates a representative computer system that may be configured to create, manage and implement information sensors.

### DETAILED DESCRIPTION

Embodiments of the present disclosure are directed to, among other things, techniques and systems for building and implementing information sensors to detect changes in Web data over time.

The techniques and systems disclosed herein provide a platform for building information sensors that can periodically crawl data sources, such as websites (e.g., news sites, retail sites, social networking sites, microblog sites, etc.), to extract, analyze and aggregate information, based on logic specified by users. The platform allows users to build information sensors within an integrated development environment (IDE) by writing, debugging and testing code therein. Additionally, or alternatively, the platform allows unsophisticated users who are not familiar with programming languages to build information sensors with the use of easy-to-use interfaces and wizard tools that are configured to automatically generate code based on user selections and inputs. In some embodiments, an interface may be built into a Web browser or mobile application to allow for user creation of an information sensor.

The techniques and systems described herein may be implemented in a number of ways. Example implementations are provided below with reference to the following figures.

### Example Architecture

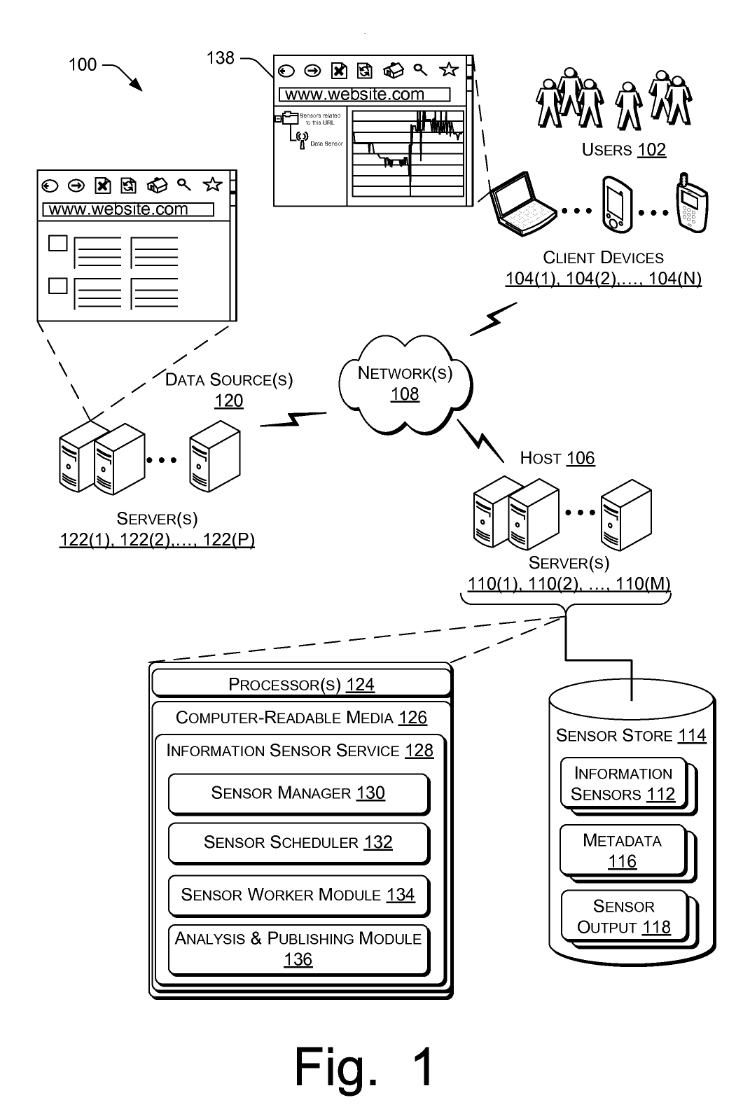

FIG. 1 illustrates an example architecture 100 for building and implementing information sensors used to sense the dynamics of Web data.

In the architecture 100, one or more users 102 are associated with client computing devices (“client devices”) 104(1), 104(2) . . . , 104(N) that are configured to access a host 106 via a network(s) 108. Users 102 may be individuals (e.g., developers, unsophisticated Web users, etc.), organizations/enterprises, or any other suitable entity. The users 102 may utilize the client devices 104(1)-(N) or an application associated with the client devices 104(1)-(N) to access websites provided from various data sources on the network 108, and may also receive messages on client devices 104(1)-(N) such as email, short message service (SMS) text messages, messages via the application associated with the client devices 104(1)-(N), calls, and the like, via the network(s) 108. The client devices 104(1)-(N) may be implemented as any number of computing devices, including a personal computer, a laptop computer, a portable digital assistant (PDA), a mobile phone, a tablet computer, a set-top box, a game console, a server or cluster of servers (e.g., enterprise users), and so forth. Each client computing device 104(1)-(N) is equipped with one or more processors and memory to store applications and data. According to some embodiments, a browser application is stored in the memory and executes on the one or more processors to provide access to a site of the host 106 and/or other websites. The browser renders webpages served by the site of the host 106 on an associated display. Although embodiments are described in the context of a web-based system, other types of client/server-based communications and associated application logic could be used. The network(s) 108 is representative of many different types of networks, such as cable networks, the Internet, local area networks, mobile telephone networks, wide area networks and wireless networks, or a combination of such networks.

The host 106 may be hosted on one or more servers 110(1), 110(2) . . . , 110(M), perhaps arranged as a server farm or a server cluster. Other server architectures may also be used to implement the host 106. The host 106 is capable of handling requests, such as in the form of a uniform resource locator (URL), from many users 102 and serving, in response, various information and data, such as in the form of a webpage, to the client devices 104(1)-(N), allowing the user 102 to interact with the data provided by the servers 110(1)-110(M). In this manner, the host 106 is representative of essentially any site supporting user interaction, including informational sites, online retailer sites, electronic commerce (e-commerce) sites, social media sites, blog sites, news and entertainment sites, and so forth.

In some embodiments, the host 106 represents a service for creating and managing information sensors 112. It is to be appreciated that the host 106 may offer other services in addition to the information sensor service. The users 102 may be able access the host 106 over the network 108 to build and implement information sensors 112 that are configured to extract structured information specified by the users 102. In some embodiments, the server(s) 110(1)-(M) are capable of providing the service in the “cloud” (i.e., users 102 may access service over the network 108) and/or downloading at least portions of the service to the client devices 104(1)-(N) over the network(s) 108.

The server(s) 110(1)-(M) may store data in a sensor store 114, which may be any suitable type of data store for storing data, including, but not limited to, a database, file system, distribution file system, or a combination thereof. The sensor store 114 may include the aforementioned information sensors 112, indexed by a unique identifier (ID), in association with metadata 116 which may include properties (e.g., update frequency, versions kept, etc.), code, and constraints of the information sensors. In some embodiments, the sensor store 114 further includes sensor output 118, which may include the core data points of interest (i.e., monitored data), along with any meta-information (e.g., version, time, etc.). The sensor output 118 is obtained upon execution of the information sensors 112 and is periodically updated at intervals according to the update frequency of the information sensors 112. It is to be appreciated that the sensor store 114 may maintain any other suitable type of information or content. For example, the sensor store 114 may include summary descriptions of each information sensor 112 to enable browsing and searching functionality, among other things.

The architecture 100 may further include data sources 120, such as news sites, retail sites, e-commerce sites, social networking sites, search engine sites, blog or microblog sites, and other similar data sources 120. The data sources 120 often contain information that is of interest to a user 102 (e.g., price of a product), and the user 102 may be further interested to know how this information changes over time. For example, the user 102 may desire to know whether the current price of a product on a retail site is the lowest during the past month, or when will be the best time to buy the product. In addition, the user 102 may want to be notified when the price has changed, etc. By creating and implementing an information sensor 112 to periodically extract the price of the product over time, the user 102 may be able to understand the dynamics of the product price over time.

As another example, an enterprise (i.e., user 102) may desire to know the sentiment surrounding one of their new products on the market, such as a tablet computer. The enterprise may build an information sensor 112 to obtain the top search results from a search engine site using a query directed toward their tablet computer (e.g., query=“ABC Tablet Computer”). The search results (e.g., webpages, documents, etc.) may then be analyzed using natural language processing (NLP) or a similar content analysis technique to learn a sentiment associated with each search result. The sentiments may then be aggregated and output as a number of positive, negative or neutral sentiments relating to the ABC Tablet Computer. This allows the enterprise user to understand how sentiment about their product(s) changes over time.

Continuing with reference to FIG. 1, the data sources 120 may utilize one or more servers 122(1), 122(2), . . . , 122(P) to serve, publish, broadcast, or otherwise present, information over the network(s) 108. The server(s) 122(1)-(P) may be implemented as any number of computing devices capable of serving content over a wide area network. In some embodiments, the server(s) 122(1)-(P) may be capable of handling requests, such as in the form of a URL, from many users 102 and serving, in response, various information (e.g., webpages) to the client devices 104(1)-(N), allowing the users 102 to interact with the data provided by the servers 122(1)-(P). In yet other embodiments, the data sources 120 may broadcast information via any suitable medium which may be consumed by the users 102 via the client devices 104(1)-(N). Although embodiments are predominantly described in the context of a web based system, other types of client/server-based communications and associated application logic could be used.

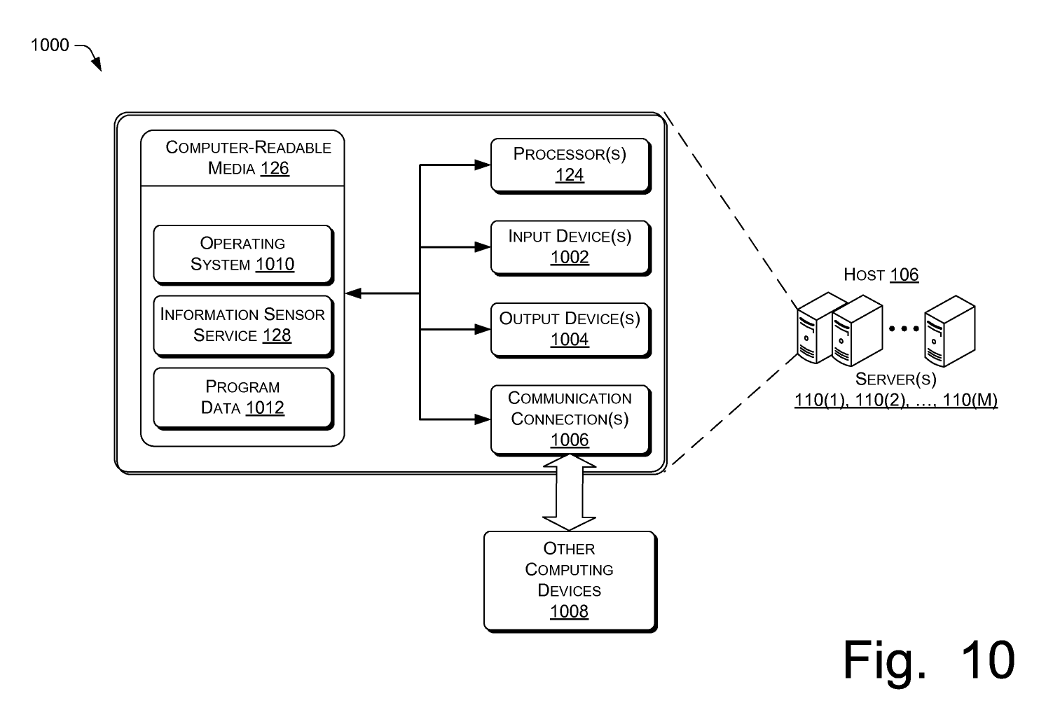

Servers 110(1)-(M) are equipped with one or more processors 124 and one or more forms of computer-readable media 126. A representative computing device and its various component parts will be described in more detail below with reference to FIG. 10. In general, the computer-readable media 126 may be used to store any number of functional, or executable, components, such as programs and program modules that are executable on the processor(s) 124 to be run as software. The components included in the computer-readable memory 126 may include an information sensor service 128 to facilitate the creation, management and implementation of the information sensors 112 maintained in the sensor store 114.

In some embodiments, the information sensor service 128 includes one or more software application components such as a sensor manager 130, a sensor scheduler 132, a sensor worker module 134, an analysis and publishing module 136. The sensor manager 130 is configured to process management requests received from the client devices 104(1)-(N). Management requests may include, but are not limited to, sensor creation, sensor configuration, sensor enablement or disablement, sensor deletion, and the like. In some embodiments, in response to a creation request for an information sensor 112, the sensor manager 130 is configured to compile the code of the submitted information sensor 112 to check whether the code is runable (i.e., error-free). If the code is runable, the sensor manager 130 may allocate a working folder for the information sensor 112, and save associated metadata 116 in the sensor store 114. In some embodiments, an executable binary is built by the sensor manager 130 and saved into the working folder.

The sensor scheduler 132 is configured to periodically retrieve and scan metadata 116 of the information sensors 112 from the sensor store 114, and to schedule execution of the information sensors 112 based on the start times and update frequencies specified in the metadata 116. In this sense, the sensor scheduler 132 may be configured to check whether a running condition of each information sensor 112 is satisfied (i.e., whether the current time=the start time of the information sensor 112), and if the running condition is satisfied for an information sensor 112, the sensor scheduler 132 may assign an executable component called a “worker” to the information sensor 112 and request the worker to execute the information sensor 112 by passing an information sensor ID to the worker.

The workers that are to be assigned to the information sensors 112 are managed by the sensor worker module 134. Accordingly, the sensor worker module 134 is configured to task workers with executing the information sensors 112, as requested by the sensor scheduler 132. Each worker may retrieve the metadata 116 from the sensor store 114 detailing the specified update frequency, stop time, etc., by utilizing the information sensor ID received from the sensor scheduler 132, and the worker executes the information sensor 112 by initializing a running timestamp and assigning a new version number for the information sensor 112. Accordingly, the sensor worker module 134 is also configured to access the data source(s) 120 over the network(s) 108 in order to extract the data element specified in the code of the information sensor 112. The output data resulting from the execution of each information sensor 112 is collected and saved as sensor output 118, which may further comprise meta-information such as the versions and times associated with each extracted data point.

In some embodiments, the data points obtained by the information sensors 112 are to be analyzed and further processed to obtain information that is useful to the users 102. For example, perhaps a user 102 desires to know whether the current price of a product listed on a retail website is the lowest price during the past month. The analysis and publishing module 136 is configured to analyze sensor output 118 from the information sensor 112 that extracted the price information for this product to determine the answer to such a query. The analysis and publishing module 136 may be further configured to publish sensor output 118 obtained by the information sensors 112. The publishing may be done via a Web service, such that the published data is accessible via the application associated with the client devices 104(1)-(N). FIG. 1 shows an example screen rendering 138 of published data from an information sensor 112 that may be accessed via the client device 104(1) using a Web browser or application. It is to be appreciated that additional, or alternative, means of publishing the sensor output 118 may be provisioned by the analysis and publishing module 136, such as by email, short message service (SMS) text messages, and the like.

In some embodiments, the analysis and publishing module 136 may be configured to publish information pertaining to the information sensors 112 themselves and the metadata 116 associated therewith. For example, the analysis and publishing module 136 may provide an interface to allow the users 102 to search the information sensors 112 using specific keywords, and to get the latest sensor output 118 of a specified information sensor 112 within a specified time range. As another example, the metadata 116 may be retrieved for specific information sensors 112 such that a user 102 can look up the update frequency of an information sensor 112.

Although the information sensor service 128 is shown in FIG. 1 as being implemented on the servers 110(1)-(M) of the host 106, at least some portions of the information sensor service 128 may be downloaded and implemented upon the client devices 104(1)-(N). For example, each user 102 may have a small number of information sensors 112 that run locally on their respective client device 104(1)-(N) to help them track the latest information on the Web. Accordingly, each client device 104(1)-(N) may have its own sensor store, similar to sensor store 114, to store a suitable number of information sensors 112, as well as related metadata 116 and sensor output 118. The client devices 104(1)-(N) may further have implemented thereon any or all of the modules 130-136 which may be downloadable and executable on the client devices 104(1)-(N). In some embodiments, portions of the information sensor service 128 may run on the client devices 104(1)-(N), while other more data-intensive portions of the service run on the servers 110(1)-(M). Similarly, users 102 that are organizations/enterprises may host a relatively large number of information sensors 112 on one or more private clouds. It is contemplated that intelligence models and tools may be developed and applied over the information sensors 112 to enable the users 102 to learn various information pertaining to the raw data obtained from the information sensors 112.

It is also to be appreciated that the information sensor service 128 may be offered as a publicly accessible service to users 102 for free, or for a subscription or other type of fee structure. The information sensor service 128 may further partition user-spaces by offering private and personal information sensor clouds, perhaps accessible by login to a user account with credentials specified by the user 102.

### Example Information Sensor Structure

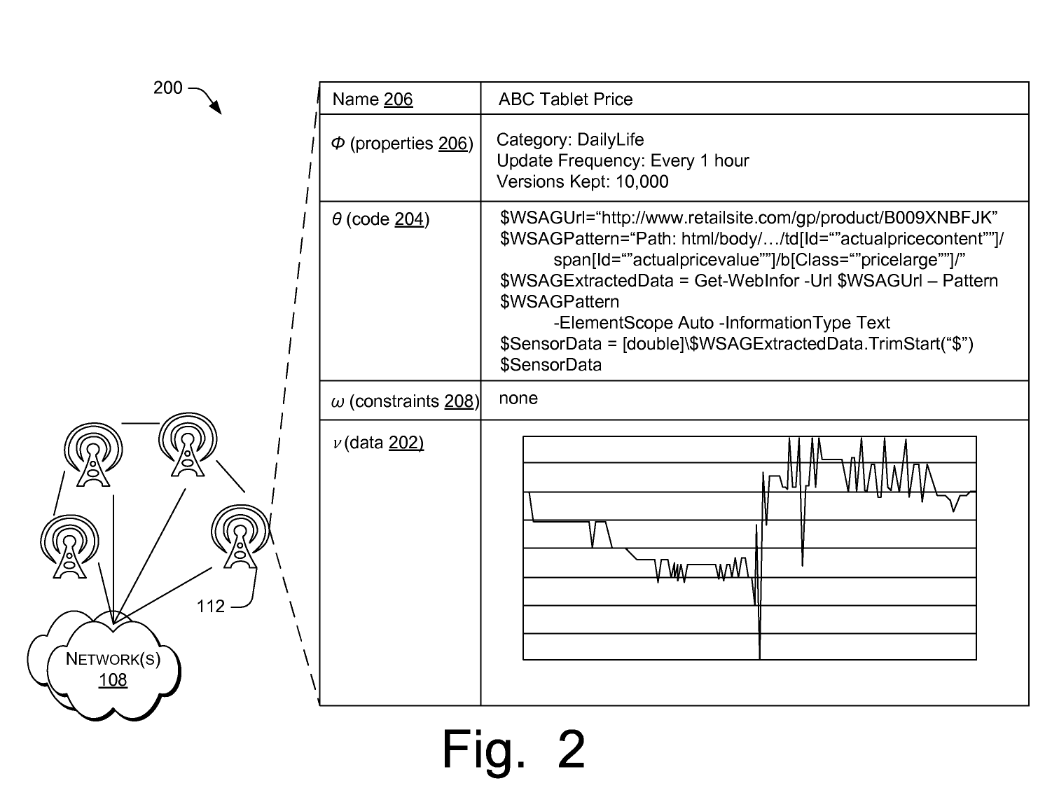

FIG. 2 illustrates an example structure 200 of an information sensor 112. An information sensor 112 is essentially a tuple, in the format of μ=(ν, θ, Φ, ω). Here, ν is the core data element 202 managed by the information sensor 112. The core data element 202 is output over a number of measurements (i.e., data points) as a structured time series. The data points in the time series can be of various data types and/or formats. For example, the data element 202 can be a numeric value, a string, a hypertext markup language (HTML) element, a picture, a distribution, an entire webpage, or any data type defined by users 102.

θ represents a program (or code 204) to produce ν (core data element 202). Different information sensors 112 may have different code 204, the code being based on the actual information that the user 102 wants to obtain and the specific logic utilized by the user 102. The code may further be in any programming language (e.g., script).

Φ represents properties 206 of the information sensor 112. An example list of properties that may be specified for an information sensor 112 is shown in Table 1, below. It is to be appreciated that a sensor may have any or all of the properties 206 listed in Table 1, including additional properties 206 not shown in Table 1.

TABLE 1
Example Properties of an Information Sensor

| Name | Description |
|---|---|
| ID | Unique identifier of the information sensor |
| Author | A string indicating the person who created the |
| | information sensor |
| Name, | Name, description, and tags are searchable fields |
| description, tags | that are used to describe what the sensor is for |
| Category | Category that the sensor is classified into |
| Update frequency | e.g., 10 seconds, 1 day, 1 week, etc. |
| Start time | The time when the sensor will run for the first time |
| Expire time | The sensor will not run again after expire time |
| #versions kept | Number of data versions that are kept for the |
| | information sensor |
| Status | Enabled or disabled |
| Data type | The type of data output by the sensor. It is either |
| | detected automatically or specified by the user |
| Current version | Current data version |
| Last run time | The time when the sensor was executed last time |

ω represents constraints 208 which may be specified to allow for the user 102 to program the information sensor 112 to function the way they intended. For example, a constraint 208 applied to the information sensor 112 may specify that it only returns numeric data within a specific range.

Information sensors 112 generally are programmable with user-customizable code 204 in order to specify the type of data to extract and from what data sources 120 it is to extract the data from. By allowing user programming of the information sensors 112 to extract a particular type of data, an information sensor 112 may be designed around a topic of the user's choice. The core data element 202 extracted over periodic intervals is output as structured, time series data that may be visualized in any format (e.g., tabular, graphs, charts, etc.).

### Example Implementation

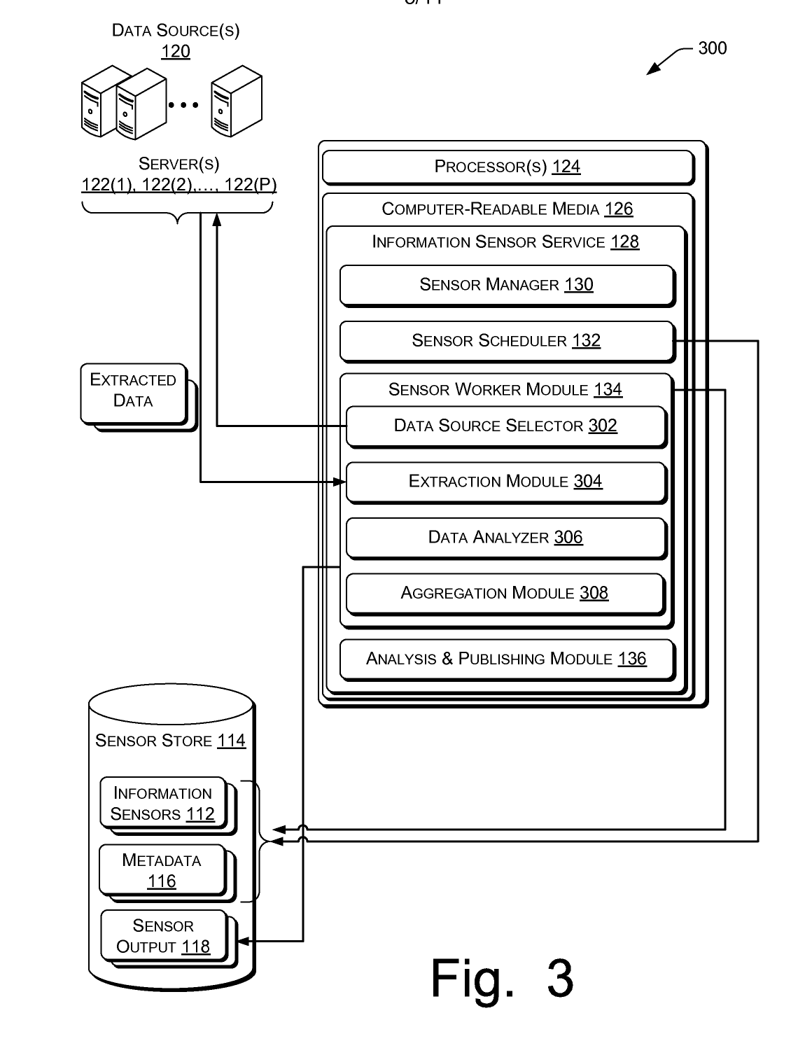

FIG. 3 is a block diagram illustrating an example implementation 300 of the information sensor service 128 which further includes a sensor worker module 134 with various modules therein for executing an information sensor 112. As described above, the sensor worker module 134 is configured to task workers with executing the information sensors 112, as requested by the sensor scheduler 132. Accordingly, the sensor worker module 134 may include a data source selector 302, an extraction module 304, a data analyzer 306, and an aggregation module 308. The data source selector 302 is configured to locate and select a data source 120 (e.g., retail site, microblog site, etc.) which includes one or more data elements to be extracted. The data source 120 may be specified by the user in the code 204 of the information sensor 112.

The extraction module 304 may be configured to extract one or more data elements within the data source 120 as specified in the code 204 of the information sensor 112. Accordingly, the extraction module 304 may be capable of mining the data source 120 by looking for various data types identified in the code 204 of the information sensor, such as numeric values, strings, HTML data, tables, distributions, sentiments, and the like. In some embodiments, predefined application programming interfaces (APIs) may be used for information gathering (i.e., extraction) algorithms configured to extract particular data elements of a particular data type. For example, functions may include, but are not limited to: extracting HTML content given a webpage and a document object model (DOM) path, extracting all hyperlinks, images, tables, and/or lists within a webpage, getting top search results from a specific search engine or website (e.g., top posts from a social networking site), extracting comments from a specific website (e.g., blogs, microblogs, etc.), getting Rich Site Summary (RSS) feeds from a website, and the like. These and other functions, in any combination, may be utilized by the users 102 in building an information sensor 112 for extracting particular data of their choice.

The extraction module 304 is further configured to extract the one or more data elements according to the metadata 116 accessed within the sensor store 114. The metadata 116 includes properties 206 defined for the information sensor 112. For example, an update frequency may be specified by a user when building or modifying the information sensor 112 such that the extraction of the data element from the data source 120 is to occur at predetermined intervals per the update frequency. For example, the update frequency could be specified as hourly, daily, twice daily, weekly, monthly, etc. The update frequency is configurable by the user 102 who builds the information sensor 112. Additional properties 206, such as a number of versions to be kept (#versions kept) may be adhered to by the extraction module 304 such that the extraction of the data elements will cease after the number of versions reaches the #versions kept.

The data analyzer 306 may be configured to analyze the extracted data for various purposes. For example, a user 102 may be interested to build an information sensor 112 that analyzes sentiment on the Web pertaining to a topic, such as a product or service, or candidates in a presidential election. Accordingly, the data analyzer 306 may utilize data mining and analysis algorithms that include, but are not limited to: analyzing sentiment over text, extracting entities, like a person name, from text, extracting frequent items (e.g., words or phrases) in a set of webpages. The data analyzer may use content analysis techniques such as natural language processing (NLP), image analysis (e.g., facial recognition), and the like for analyzing extracted data for various purposes.

The aggregation module 308 is configured to aggregate some or all of the data points collected at each interval of the update frequency. For example, when the information sensor 112 is programmed to crawl multiple data sources 120 to periodically extract data from each of the multiple data sources 120, the aggregation module 308 may aggregate the collected data at each interval to generate “high-order knowledge,” which may include determining an average, median or mode value across the aggregated data elements and storing the average, median or mode as a data point in the structured time-series. As another example, data points across one or more data sources 120 that pertain to multi-order data, such as sentiment (i.e., positive, negative, or neutral) may be aggregated and tallied/counted to determine a data point for each interval. More specifically, an information sensor 112 in charge of obtaining sentiment surrounding a new tablet computer may run daily to extract a predetermined number of search results from a search engine based on a query of the specific tablet computer. These daily search results may be analyzed over text to determine sentiment as positive, negative or neutral pertaining to the tablet computer. The aggregation module 308 may then aggregate all of the positive results, all of the negative results, and all of the neutral results into three buckets, may tally each one, and may plot the data points in time-series for the information sensor 112.

### Example Processes

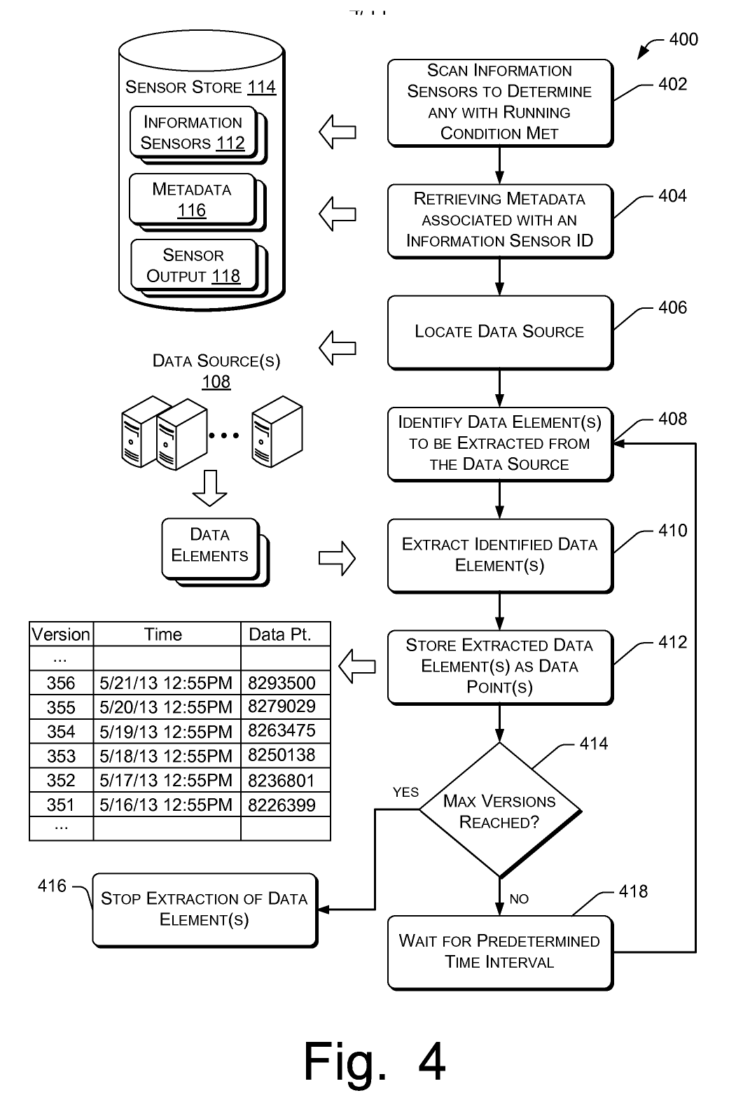

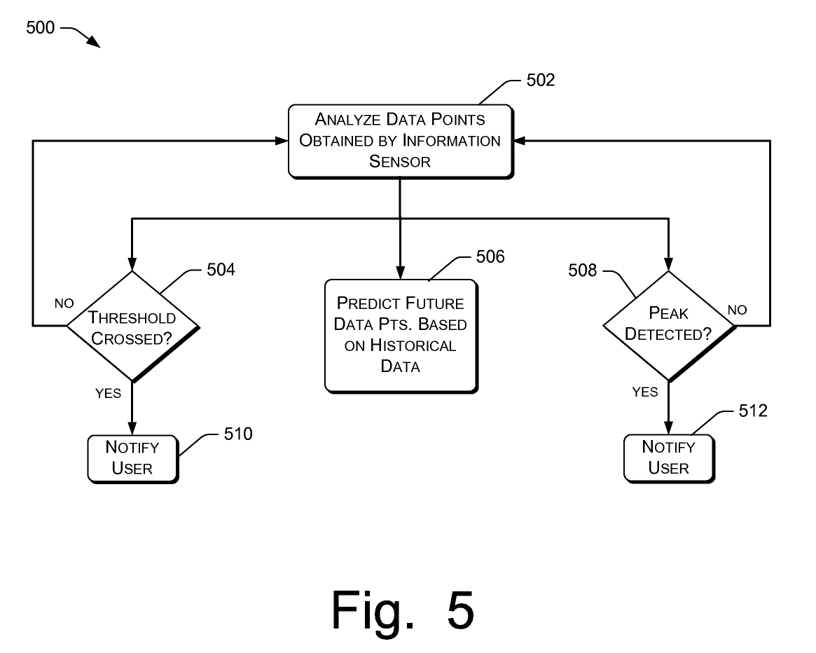

FIGS. 4 and 5 describe illustrative processes that are illustrated as a collection of blocks in a logical flow graph, which represents a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 4 is a flow diagram of an illustrative process 400 for executing an information sensor 112 to extract structured information from a data source 120 at a predetermined update frequency. For discussion purposes, the process 400 is described with reference to the architecture 100 of FIG. 1, and the implementation 300 of FIG. 3. Specifically the process 400 is described with reference to the sensor scheduler 132 and the sensor worker module 134, as well as the data source selector 302, and extraction module 304.

At 402, information sensors 112 that are stored in the sensor store 114 are scanned by the sensor scheduler 132 and compared against a current time (i.e., date and time) to determine whether a running condition is met. For example, if an information sensor 112 is programmed to start on Tuesday, May 7 at 8:00 A.M., the running condition will be met when the current time is equal to the programmed start time. In some embodiments, the sensor scheduler 132 is configured to scan the information sensors 112 periodically (e.g., every 5 minutes, every hour, etc.) to determine whether a running condition is met for any of the information sensors 112. Upon determining that a running condition is met for at least one information sensor 112 in the sensor store 114, the sensor scheduler may then pass the ID of the information sensor 112 to the sensor worker module 134 to assign a worker to the information sensor 112.

Upon assignment of a worker to the information sensor 112, the worker then retrieves, at 404, metadata 116 associated with the information sensor 112 by looking up the metadata 116 in the sensor store 114 using the sensor ID. Having retrieved the metadata 116 at 404, the worker may then initiate execution of the information sensor 112 by starting/running the code contained in the metadata 116 in a working folder for the information sensor 112. In some embodiments, the worker may initialize a running timestamp and a version counter for recordation at each interval of the update frequency specified in the metadata 116.

At 406, the sensor execution process begins by locating a data source 120 from which data is to be extracted. The data source 120 may be specified in the code 204 included in the metadata 116 for the information sensor 112, as programmed by a user 102. For example, the data source 120 may be a retail website containing products or services for sale to consumers.

At 408, one or more data elements to be extracted are identified within the data source 120. For example, a price of a product on the retail website may be identified per the code 204 in the metadata 116 of the information sensor 112. As another example, a query may be submitted to a search engine on a general search site or a focused website (e.g., social networking site), and a subset of top search results may be identified as the data elements to be extracted from the website.

At 410, the identified one or more data elements are extracted from the data source 120, and at 412, the extracted data elements are stored as data points in the sensor store 114. The outputted data points may be stored as sensor output 118 within the sensor store 114, and may be associated with meta-information such as a time, version, data type, or other suitable meta-information. FIG. 4 shows a table of extracted data elements stored during the process 400.

At 414, a determination is made as to whether a maximum number of versions has been reached for the information sensor 112. For example, the properties 206 in the metadata 116 may specify that 10,000 versions are to be kept for the information sensor 112. At 414, the worker may compare a current version count to this threshold number to determine whether the 10,000 versions number has been reached. If the maximum number of version is reached, the process proceeds to 416 where the extraction of the data is stopped, and the full data set is maintained in the sensor store 114 without further execution of the information sensor 112.

However, if it is determined at 414 that there are still more versions to run, the worker may then wait for a predetermined time interval at 418 according to the update frequency in the metadata 116 (e.g., 24 hours) and then repeat steps 408-414 until the maximum number of versions is met.

FIG. 5 is a flow diagram of an illustrative process 500 for analyzing data points obtained by an information sensor 112 and carrying out multiple options including determining a threshold crossing within the data, detecting peaks within the data, and/or forecasting future data points based on historical data. The illustrative process 500 may be executed in parallel to the process 400 of FIG. 4, such as in a “real-time” mode to analyze data points as they are being obtained by the information sensor 112, or the process 500 may be executed serially to the process 400 after all of the data points have been collected and stored in the sensor store 114. For discussion purposes, the process 500 is described with reference to the architecture 100 of FIG. 1, as well as the implementation 300 of FIG. 3. Specifically the process 500 is described with reference to the analysis and publishing module 136.

At 502, the analysis and publishing module 136 may analyze collected data points obtained by an information sensor 112. As mentioned above, these data points may have been recently collected, and the information sensor 112 may still be executing under control of a worker. Additionally, or alternatively, all of the data points may have been collected at any point in the past, and the information sensor 112 may be finished executing. In any case, once the data points are analyzed at 502, the process may proceed to one or more of the steps 504-508.

At 504, the analysis and publishing module 136 may determine whether a threshold has been crossed within the data set. In some embodiments, the analysis and publishing module 136 determines whether any two consecutive data points straddle, or lie on either side of, a predefined threshold value. Such an observation may be indicative of a threshold being crossed at 504. If the analysis and publishing module 136 determines that a threshold has not been crossed, it continues to analyze the data points at 502, perhaps as more data points are collected by a currently executing information sensor 112. If it is determined at 504 that a threshold has been crossed, a user 102 associated with the information sensor 112 may be notified of this event at 510. Such a notification may be issued by any conventional means, such as email, SMS text, publication to a user account and accessible by the user 102 via a Web application using a client device 104(1)-(N).

At 506, the analysis and publishing module 136 may predict future data points to be collected by the information sensor 112 based on historical data points. The prediction at 506 may be accomplished by any suitable forecasting technique, such as time series methods (e.g., extrapolation), regression analysis, etc. Accordingly, a user 102 who is trying to determine, for example, a good time to buy a product that fluctuates in price over time can request the analysis and publishing module 136 to forecast future data points and determine when the price is most likely to be at a low peak (i.e., the cheapest price).

At 508, the analysis and publishing module 136 may determine whether there is a peak in the data set. That is, a lowest or highest data point, among the set of data points collected, may be determined at 508. In some embodiments, this may occur after a full data set is collected and a minimum or maximum data point is detected. In yet other embodiments, such as in a “real-time” scenario with a still-running information sensor 112, a peak may be detected at 508 for every data point extracted that is a “new low,” or a “new high.” If a peak is not detected at 508, the analysis and publishing module 136 may continue analysis of the data points. If a peak is detected at 508, a user 102 may be issued a notification at 512 to inform them of this peak detection. Such notification at 512 may be similar to that described with reference to 510.

### Example Information Sensor Creation and Management

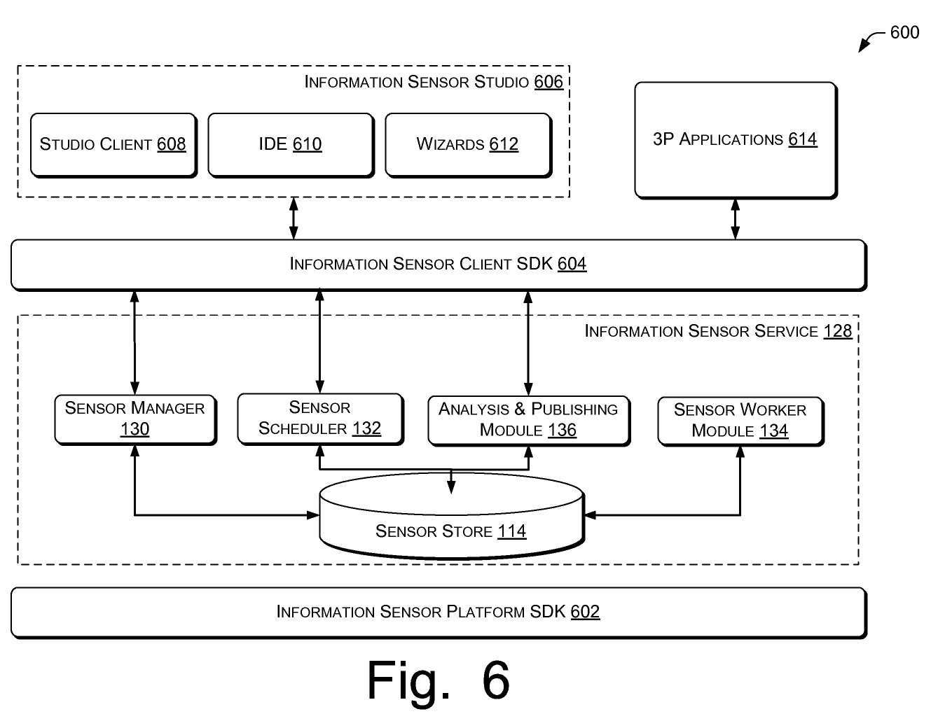

FIG. 6 illustrates an example architecture 600 of an information sensor platform for creation and management of information sensors 112. The architecture 600 is designed to give users 102 the freedom to build information sensors 112 with customized extraction algorithms, and to help manage and implement the information sensors 112, once created.

In some embodiments, the architecture 600 may include an information sensor platform software development kit (SDK) 602 (“platform SDK 602”). The platform SDK 602 is a fundamental layer of the architecture 600 which defines basic data structures, like “InformationSensor” and “InformationSensor Data,” used by the other layers of the architecture 600. Common data types may also be defined in the platform SDK 602, which may include, but are not limited to, Numeric, String, Html, HtmlElement, Table, Distribution, Sentiment, and the like. The sensor output 118 of FIG. 1 may include data of such data types defined in the platform SDK 602. These predetermined data types also facilitate visualization, management and analysis of the sensor output 118, as well as design of user applications.

In some embodiments, the platform SDK 602 further defines the information gathering algorithms utilized by the extraction module 304 for extracting data elements (e.g., extracting HTML content given a webpage and a DOM path, extracting all hyperlinks, images, tables, and/or lists within a webpage, etc.). The platform SDK 602 may further define data mining and analysis algorithms utilized by the data analyzer 306 for analyzing data that has been extracted (e.g., analyzing sentiment over text, extracting entities, like a person name, from text, extracting frequent items (e.g., words or phrases) in a set of webpages, etc.).

In some embodiments, the platform SDK 602 may further define functions for getting data from the information sensors 112, such that information sensors 112 may be layered (i.e., one information sensor 112 may rely on another information sensor 112). In some embodiments, the platform SDK 602 provides a set of APIs which are designed to accomplish any of the aforementioned tasks.

The architecture 600 of FIG. 6 is shown to further include the information sensor service 128, as previously described with reference to FIGS. 1-5. The information sensor service 128 is configured to host the information sensors 112 within the sensor store 114, and to manage, schedule and execute the information sensors 112. In some embodiments, the information sensor service 128 is configured to analyze and publish data obtained by the information sensors 112. The modules of the information sensor service 128 may be similar to those discussed with reference to FIGS. 1-5.

The architecture 600 may further include an information sensor client SDK 604 (“client 604”) which is essentially a middle layer between the information sensor service 128 and applications building and/or consuming the information sensors 112. The client SDK 604 may be a central access point to the information sensor service 128 for management and data access requests, and may define a set of APIs for accessing the information sensor service 128 as a client proxy. In some embodiments, the client SDK 604 further defines analysis functions over structured time-series data obtained by the information sensors 112. The analysis functions may be utilized by the analysis and publishing module 136 for such things as peak detection, event notification, time-series similarity calculation, trend prediction, or any other suitable analysis functions.

The architecture 600 may further include an information sensor studio 606 which is a set of tools provided to end users 102 to enable the users 102 to create, submit, view and manage information sensors 112. The information sensor studio 606 may comprise a studio client 608, an integrated development environment (IDE) 610, and a set of wizard tools 612. It is to be appreciated that each of the studio client 606, IDE 610 and wizard tools 612 may either be implemented in separate executable files, or integrated into a single toolbox for the information sensor studio 606.

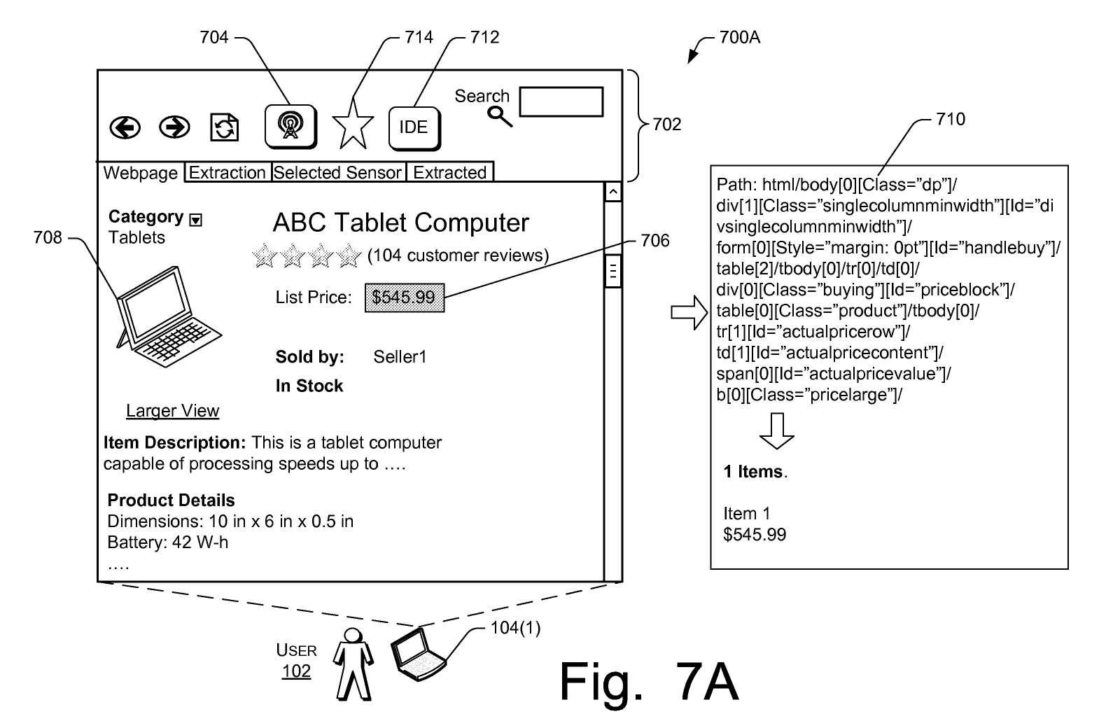

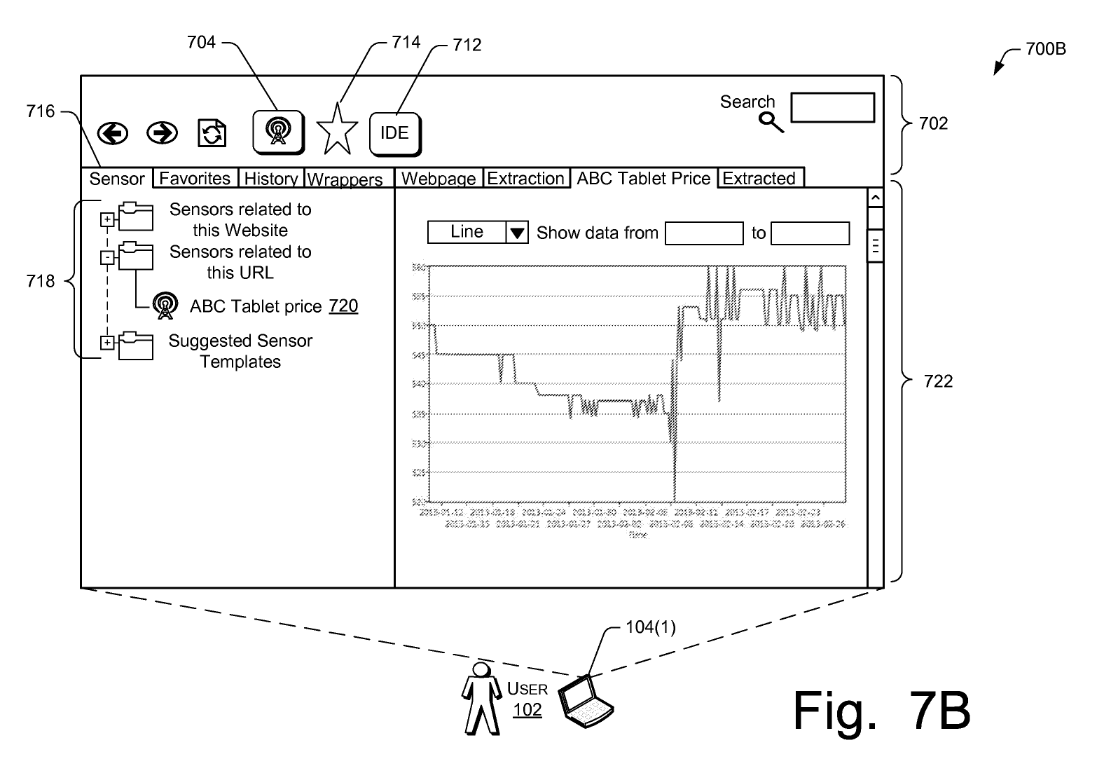

The studio client 608 may be a build-in application (built on top of the client SDK 604) for users 102 to view, submit, change, and delete information sensors 112. The studio client 608 may utilize visualization tools to visualize published sensor output 118 from the analysis and publishing module 136. Example creation and visualization tools will be described in more detail below with reference to FIGS. 7A and 7B.

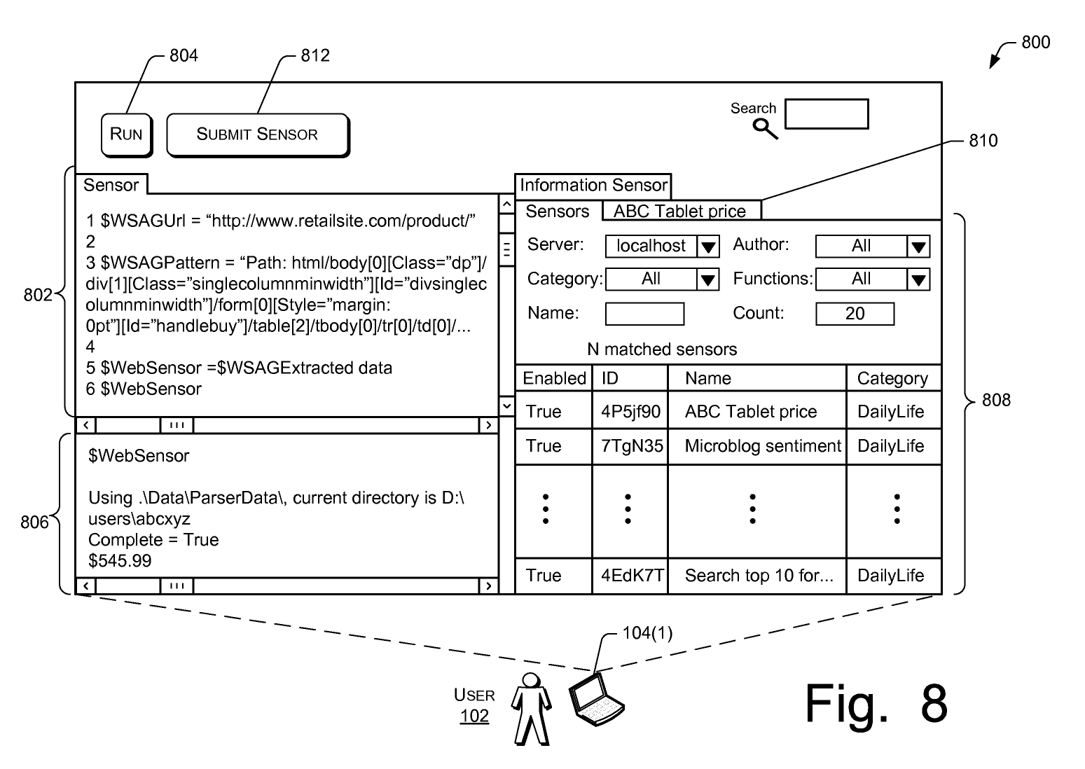

The IDE 610 is a component that may be provided to users 102 who have some development knowledge to build and implement information sensors 112. The IDE 610 allows users 102 to write, debug and test code for information sensors 112. An example IDE interface will be described in more detail below with reference to FIG. 8.

Wizard tools 612 are provided to users 102 who may be less familiar with programming in the IDE 610, and/or to developers who may specify some basic properties of information sensors 112 through selectable interfaces. The wizard tools 612 may be configured to automatically generate code and create information sensors 112 based on selections and inputs received from users 102. As such, experienced developers may utilize wizard tools 612 to automatically generate code, and then modify the generated code to satisfy their information need. In some embodiments, the wizard tools 612 allow for specification of information sensors 112 to: get the top n search results from a search engine e for a given query q, where n, e, and q are specified by users 102, get a specific HTML element from a webpage p, extract a list of products from a commercial webpage p, extract sentences from a webpage p, analyze sentiment for a target t from the text of a webpage p, or get snapshots of a webpage p, and the like.

The architecture 600 further contemplates third party applications 614 (“3P applications 614”) that include applications built on top of the information sensors 112 to perform various tasks for users 102. For example, a mobile phone application may be built on top of one of more information sensors 112 to further analyze, aggregate and present data to users 102.

FIG. 7A illustrates an example screen rendering of a user interface (UI) 700A enabling user selection of a data element within a data source 120 for extraction by an information sensor 112. The UI 700A shows a retail site of a merchant who sells items (i.e., products or services) to consumers. Accordingly, the UI 700A includes searching/browsing tools and buttons 702, such as a search field for entering queries used when searching an item catalog, and browser navigation tools/buttons (e.g., page forward, page backward, refresh, etc.) to facilitate browsing an online item catalog.

The tools and buttons 702 may further include a create sensor button 704. The create sensor button 704, upon selection by a user 102, invokes the studio client 608 via the information sensor studio 606 described in FIG. 6 to allow for user selection of a data element on the webpage that the user desires to have monitored. For example, the user 102 may be interested in tracking the list price 706 of a product 708 (shown in FIG. 7A as the “ABC Tablet Computer”). Upon selection of the create sensor button 704, the user may subsequently select the list price 706 (i.e., data element) using any suitable pointing mechanism (e.g., mouse, joystick, touch screen input, etc.) to specify the list price 706 as the data element of interest to the user 102.

In response to the user selection of the list price 706, the studio client 608 may automatically generate code 710 (e.g., automatically generated wrappers) as a basic, default information sensor 112 for tracking the list price 706 of product 708. An unsophisticated user 102 may be satisfied with the default information sensor 112 created from these basic steps, and may forego further modification or creation processes for the information sensor 112. Additionally, or alternatively, the user 102 may subsequently select the IDE button 712 to have the automatically generated code 710 exported to the IDE 610. Within the IDE 610, the information sensor 112 may be further customized through programming logic. The IDE 610 is shown and described in further detail below with reference to FIG. 8.

In some embodiments, the tools and buttons 702 may further include a favorites button 714 that, upon user selection, navigates the user 102 to a visualization tool for viewing information sensors 112 and published sensor data.

Accordingly, FIG. 7B illustrates an example screen rendering of a UI 700B enabling viewing of particular information sensors 112 and associated published data. The UI 700B may result from user selection of the favorites button 714 described with reference to FIG. 7A.

The UI 700B may include a sensor tab 716 on at least a portion of the page where a user 102 may navigate through a folder structure 718 of information sensors 112, and sensor templates. FIG. 7B shows an example information sensor 720 for the “ABC Tablet price” that was created by the user 102 in the example described with reference to FIG. 7A. Accordingly, a user 102 may select the “ABC Tablet price” sensor 720 to view the data collected by the sensor 720, which is shown in the viewing pane 722. The viewing pane 722 may provide any type of graphical representation (e.g., line chart, bar chart, etc.) or tabular view of the data collected by the information sensor 720. FIG. 7B shows the data element comprised of the price 706 of the ABC Tablet computer as fluctuating over a time period spanning just over a month. Additional tools may be provided within the viewing pane 722 to enable the user 102 to manipulate the visualization of the data, such as converting the line chart to a bar chart, or manipulating the range of data points shown on either axis of the graph.

FIG. 8 illustrates an example screen rendering of an IDE 800 for building information sensors 112. The IDE 800 may be invoked upon receipt of a user selection of the IDE button 712 shown in FIGS. 7A and 7B.

The IDE 800 may include a code editing pane 802 where code may be written by a user 102, such as a developer, to build an information sensor 112. The code editing pane 802 may also be the place where automatically generated code is imported to, such as code that is automatically generated by the studio client 608 upon user selection of a data element within a data source.

The IDE 800 may further include a run button 804 that, upon user selection, runs the code written in the code editing pane 802 to debug the code. The output of the debugging is shown within the debugging output pane 806. Here, the user 102 can view the results of running the code in the code editing pane 802 to make sure that the information sensor 112 is executing properly.

The IDE 800 may further include an information portion 808 which provides functionality to search and browse available information sensors, and may list results of information sensors 112 that are returned based on a search of the repository in the sensor store 114. In addition to global searching and browsing of the information sensors 112 in the sensor store 114, the information portion 808 may further include one or more tabs 810 that are specific to information sensors 112 associated with the user 102. FIG. 8 shows a tab 810 for the “ABC Tablet price” information sensor 112.

Once a user 102 is satisfied with the state of his/her information sensor 112, the user 102 may select the submit sensor button 812 to submit the newly created information sensor 112 to the information sensor service 128 where it may be implemented.

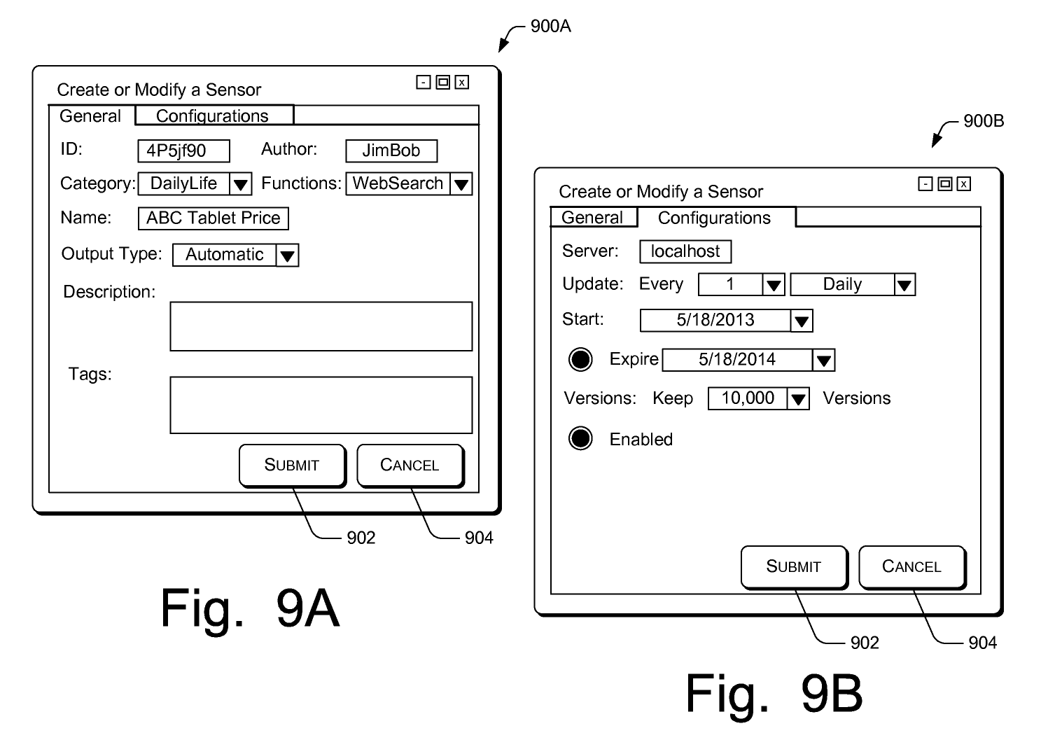

FIGS. 9A and 9B illustrate example wizard tools 900A and 900B used for specifying configurable metadata of an information sensor 112 and submitting the information sensor 112 for implementation. The wizard tools enable further specification by a user 102 of certain core properties (e.g., update frequency, #versions kept, name, etc.), constraints and other metadata 116 related to the information sensor 112.

FIG. 9A shows a wizard tool 900A that provides a user 102 with available inputs to specify general properties, such as a category, functions, a name, and an output type (e.g., automatic). Some fields in the wizard tool 900A may not be modifiable, such as the automatically generated ID for the information sensor 112. A user 102 may further provide a description and tags to better define the information sensor 112 and to facilitate searching of the information sensor 112. A submit button 902 allows a user 102 to submit the information sensor 112 to the information sensor service 128 for implementation. Additionally, a cancel button 904 allows the user 102 to exit out of the wizard tool if they decide not to go forward with building the information sensor 112 at the time.

FIG. 9B shows a wizard tool 900B that allows for other configurations of properties such as a server that the information sensor 112 is to be submitted to, an update frequency, start date, expiration date, a number of versions to keep, an enablement/disablement button, and the like. It is to be appreciated that the user 102 may not specify an expiration date to create an information sensor 112 that will not expire based on a date. Instead, it may run until a predetermined number of versions are met.

### Example Computing Device

FIG. 10 illustrates a representative system 1000 that may be used to implement the information sensor service 128 for creating, managing and implementing the information sensors 112. However, it is to be appreciated that the techniques and mechanisms may be implemented in other systems, computing devices, and environments. The representative system 1000 may include one or more of the servers 110(1)-(M) of FIG. 1. The servers 110(1)-(M) should not be interpreted as having any dependency nor requirement relating to any one or combination of components illustrated in the representative system 1000.

The servers 110(1)-(M) may be operable to facilitate creation, management and implementation of the information sensors 112 according to the embodiments disclosed herein. For instance, the servers 110(1)-(M) may be configured to receive submissions from users 102 for the creation of information sensors 112, and to manage execution of the information sensors 112, as well as manage the deletion and modification of the information sensors 112, among other things.

In at least one configuration, the servers 110(1)-(M) comprises the one or more processors 124 and computer-readable media 126 described with reference to FIG. 1. The servers 110(1)-(M) may also include one or more input devices 1002 and one or more output devices 1004. The input devices 1002 may be a keyboard, mouse, pen, voice input device, touch input device, etc., and the output devices 1004 may be a display, speakers, printer, etc. coupled communicatively to the processor(s) 124 and the computer-readable media 126. The servers 110(1)-(M) may also contain communications connection(s) 1006 that allow the servers 110(1)-(M) to communicate with other computing devices 1008 such as via a network. The other computing devices 1008 may include the client devices 104(1)-(N) and/or the server(s) 122(1)-(P) of FIG. 1.

The servers 110(1)-(M) may have additional features and/or functionality. For example, the servers 110(1)-(M) may also include additional data storage devices (removable and/or non-removable) such as, for example, magnetic disks, optical disks, or tape. Such additional storage may include removable storage and/or non-removable storage. Computer-readable media 126 may include, at least, two types of computer-readable media 126, namely computer storage media and communication media. Computer storage media may include volatile and non-volatile, removable, and non-removable media implemented in any method or technology for storage of information, such as computer readable instructions, data structures, program modules, or other data. The system memory, the removable storage and the non-removable storage are all examples of computer storage media. Computer storage media includes, but is not limited to, random access memory (RAM), read-only memory (ROM), erasable programmable read-only memory (EEPROM), flash memory or other memory technology, compact disc read-only memory (CD-ROM), digital versatile disks (DVD), or other optical storage, magnetic cassettes, magnetic tape, magnetic disk storage or other magnetic storage devices, or any other non-transmission medium that can be used to store the desired information and which can be accessed by the servers 110(1)-(M). Any such computer storage media may be part of the servers 110(1)-(M). Moreover, the computer-readable media 126 may include computer-executable instructions that, when executed by the processor(s) 124, perform various functions and/or operations described herein.

In contrast, communication media may embody computer-readable instructions, data structures, program modules, or other data in a modulated data signal, such as a carrier wave, or other transmission mechanism. As defined herein, computer storage media does not include communication media.

The computer-readable media 126 of the servers 110(1)-(M) may store an operating system 1010, the information sensor service 128 with its various modules and components, and may include program data 1012.

The environment and individual elements described herein may of course include many other logical, programmatic, and physical components, of which those shown in the accompanying figures are merely examples that are related to the discussion herein.

The various techniques described herein are assumed in the given examples to be implemented in the general context of computer-executable instructions or software, such as program modules, that are stored in computer-readable storage and executed by the processor(s) of one or more computers or other devices such as those illustrated in the figures. Generally, program modules include routines, programs, objects, components, data structures, etc., and define operating logic for performing particular tasks or implement particular abstract data types.

Other architectures may be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method comprising:
scanning, by one or more processors, a set of information sensors to determine that a running condition is met for executing at least one information sensor in the set of information sensors;
at least partly in response to a determination the running condition is met for the at least one information sensor, retrieving metadata associated with the at least one information sensor, the metadata including an update frequency and code to extract one or more data elements from a data source, the code being user-editable and providing predefined functions for at least extracting the one or more data elements from the data source;
running, by the one or more processors, the code to:
locate the data source,
identify the one or more data elements within the data source,
and
periodically extract the one or more data elements from the data source according to the update frequency; and
storing each extracted data element as a data point in a structured time series.

2. The method of claim 1, wherein the metadata further includes a number of versions to be kept, the method further comprising stopping the periodic extraction of the one or more data elements when a number of extracted data elements meets the number of versions to be kept.

3. The method of claim 1, wherein the data source is a website including a search engine, and wherein the identification of the one or more data elements within the data source comprises submitting a query to the search engine to identify a plurality of search results as the one or more data elements.

4. The method of claim 3, further comprising,
collecting a predetermined number of the plurality of search results,
analyzing each search result to determine a sentiment of each search result as being one of a positive, negative or neutral sentiment about the query,
aggregating the search results according to the positive, negative and neutral sentiment to determine counts of positive, negative and neutral search results; and
storing the counts of positive, negative and neutral search results as data points.

5. The method of claim 1, wherein the code specifies multiple data sources from which a plurality of data elements are to be extracted, the method further comprising aggregating each of the extracted data elements to obtain a single data point based on the aggregated data points.

6. The method of claim 1, further comprising publishing the structured time series.

7. The method of claim 1, further comprising:
analyzing the data points to determine whether any two consecutive data points lie on either side of a threshold value indicating that the threshold value has been crossed; and
transmitting a notification that the threshold value has been crossed to a user device.

8. The method of claim 1, further comprising:
analyzing the data points to determine a maximum or minimum value among the data points indicative of a peak among the data points, and
transmitting a notification of the peak to a user device.

9. The method of claim 1, further comprising analyzing the data points to forecast future data points to be obtained by the information sensor over a time period.

10. A system for executing an information sensor, the system comprising:
one or more processors;
one or more memories comprising:
a sensor scheduler maintained in the one or more and executable by the one or more processors to periodically scan a set of information sensors to determine that a running condition is met for execution of at least one information sensor in the set of information sensors, the at least one information sensor having an identifier (ID);
a sensor worker module maintained in the one or more memories and executable by the one or more processors to retrieve metadata associated with the ID and to assign a worker to the at least one information sensor to execute the information sensor, the metadata including an update frequency and code that is user-editable to provide predefined functions for at least extracting one or more data elements from a data source, the worker being configured to run the code to:
locate the data source,
identify the one or more data elements within the data source to be extracted, and
periodically extract the one or more data elements according to the update frequency, and
the sensor worker module being configured to store each extracted data element in a database in association with a time and a version number associated with each extracted data element.

11. The system of claim 10, wherein the data source is a website including a search engine, and wherein the identification of the one or more data elements within the data source comprises submitting a query to the search engine to identify a plurality of search results as the one or more data elements.

12. The system of claim 10, wherein the one or more data elements include at least one of hypertext markup language (HTML) content, hyperlinks, images, tables, search results, comments, posts, or rich site summary (RSS) feeds.

13. The system of claim 10, further comprising an analysis and publishing module maintained in the one or more memories and executable by the one or more processors to forecast future data points to be obtained by the information sensor over a time period based at least in part on the extracted data elements.

14. A computer-readable medium storing computer-executable instructions that, when executed, cause one or more processors to perform acts comprising:
receiving, from a user, a specification of:
a data element within a data source that the user desires to monitor using an information sensor, and
an update frequency at which the information sensor is to extract the data element from the data source,
generating code configured to extract the data element from the data source according to the update frequency, the code being further editable by the user by providing predefined functions for at least extracting the data element from the data source; and
creating the information sensor by storing the information sensor in a database along with metadata specifying the code and the update frequency.

15. The computer-readable medium of claim 14, wherein the data source comprises a website, and wherein the receiving the specification of the data element further comprises receiving a selection of the data element from the user while the user is accessing the website.

16. The computer-readable medium of claim 15, wherein the generating the code comprises generating the code in response to the selection of the data element from the user.

17. The computer readable medium of claim 14, wherein the data element is a price of an item, and the data source is a website displaying the item for sale.

18. The computer readable medium of claim 17, wherein the code is further configured to determine at least one of a lowest price of the item over a period of time in the past, or an optimal time period in the future during which the price may be at a low point.

19. The computer readable medium of claim 14, wherein the receiving the specification of the update frequency further comprises receiving a selection of update frequency from the user via a wizard tool.

20. The computer readable medium of claim 14, wherein the receiving the specification of the data element further comprises receiving a specification of at least one of the following predefined functions: get a top subset of search results from a search engine for a given query, get a specific hypertext markup language (HTML) element from a webpage, extract a list of products from a webpage, extract sentences from a webpage, analyze sentiment for a target from text of a webpage, or get snapshots of a webpage.
